(19) United States
(12) Patent Application Publication
(10) Pub. No.: US 2020/0237617 A1
(43) Pub. Date: Jul. 30, 2020

(54) Clamp Apparatus

(71) Applicant: Shawn Margaret Moore, Aurora, CO (US)

(72) Inventor: Shawn Margaret Moore, Aurora, CO (US)

(21) Appl. No.: 16/846,274

(22) Filed: Apr. 11, 2020

Related U.S. Application Data
(63) Continuation-in-part of application No. 15/151,502, filed on May 11, 2016.

(51) Int. Cl. A61H 39/04

(52) U.S. Cl. CPC A61H 39/04; A61H 2205/065; A61H 2201/0153; A61H 2201/168; A61H 2201/0157; A61H 2201/0192

(57) ABSTRACT

A clamp apparatus for clamping an article, the clamp apparatus includes a first finger and a second finger with a biased flexible connecting member wherein the bias urges the first and second fingers apart with structure to limit the bias, the connecting member is affixed to one end of each finger wherein a “V” shape is formed as between the first and second fingers and the connecting member. Also included in the clamp apparatus is a locking fastener for overcoming the connecting member urging via manually selectively bringing the first and second fingers together, plus a first extension with a first shoe disposed in the first finger and a second extension with second shoe disposed in the second finger, wherein operationally the first and second shoe portions act to clamp the article to the extent of the locking fastener.

### RELATED PATENT APPLICATION

This is a continuation in part (CIP) patent application of U.S. patent application Ser. No. 15/151,502 filed on May 11, 2016 by Shawn Margaret Moore of Aurora, Colo., US.

### TECHNICAL FIELD

This invention relates generally to clamping apparatus, most commonly but not limited to facilitating a manual clamp upon an article. More particularly to clamp through a plurality of selectable clamping pressure adjustments a body part to provide relief and comfort that has a common term of acupressure therapy.

### BACKGROUND OF INVENTION

Acupressure is an ancient method of pain relief that is considered an alternative medicine, that parallels acupuncture in concept that is based on the concept of life energy that flows through meridians in the body, wherein physical pressure is applied (via a device or manually by another person), to acupuncture points on the body, to clear blockages in the meridians, as the pressure is applied to the outer surface of the body. Acupressure is akin to other well known body pressure type therapies such as massage, chiropractic, craniosacral, rolfing, shiatsu, and so on. Studies have shown that acupressure has helped to alleviate conditions such as nausea, vomiting, back pain, tension headaches, stomach pain, emotional stress, nervousness, anxiety, stiffness, fatigue, general tension, among other items. Devices for applying acupressure outside of using a humans hands and fingers would include balls, cylindrical rollers, rollers with protrusions, with sometimes heat added to the device for additional effect to the body part.

One of the attractions of acupressure is the minimal risk associated with employing the technique by not having internal medications, no overdose risk, no side effects risk, no infection risk, no body fluid exposure, minimal cost, and minimal equipment needed, being overall generally very safe to do. After all who hasn't put their hands on their temples and applied moderate pressure for headache relief.

One benefit of using an acupressure device as opposed to using fingers or hands is the ability to more precisely control the amount of pressure and the ability to have the acupressure continue for a length of time without the burden of manually applying the acupressure via one's fingers for instance. A group of popular positions on the body for applying acupressure is in the hand webbing as between the thumb and the index finger also known as position LI4 that is believed to control the large intestine, also LR3 is the soft flesh between the big and second toe that is believed to control the liver, and SP6 that is about two inches above the inner anklebone that is believed to control the spleen as being the three most popular acupressure areas, wherein the acupressure is applied for up to about fifteen minutes per session.

An example of a prior art solution in acupressure however in combination with low level electrical current would be in U.S. Pat. No. 506,516 to Lane which is disclosed as being an electrical head clamp for relieving pain that includes a semi circular band that compresses a pair of discs against each head temple. The discs in Lane are electrically conductive material of zinc and silver that have battery power applied to them for relief of headaches. The amount of acupressure on Lane is determined by the spring effect in the semicircular band that is positioned about the head of the user.

Another example of a prior art solution in acupressure would be in United States Patent Application Publication Number 2002/0151930 to Mills for a acupressure and reflexology clamp that is “U” shaped having bulbed ends and a centrally located pivoting ratchet portion having indicia for position and a ratchet release. Further, Mills includes multiple bulbed ends having differing protrusions and shapes for differing acupressure effects.

A further example of a prior art solution in acupressure would be in U.S. Pat. No. 5,094,227 to Eglauf et al., that discloses a non-invasive pain relief apparatus which is a pivotal clamp assembly having a locking mechanism to lock the clamp at a selected position while applying a selected amount of acupressure that further includes a single sided fine tuning mechanism to more delicately adjust the amount of acupressure, wherein a pivotal release is also included to remove the clamp from the body part. The locking mechanism in Eglauf is of a radially toothed gear type that has a spring loaded plate that is squeezed for release of the toothed engagement.

In looking at clamping prior art solutions in U.S. Pat. No. 4,278,246 to Blake, disclosed is a clamping device that is provided having a pair of outwardly curved arms with pivotally mounted clamping jaws at one end thereof. In Blake, a rotatable leverage screw threadably engages pivot members which are pivotally mounted at the other end of the arms with a rotatable fulcrum screw that threadably engages pivot members which are pivotally mounted on the arms intermediate the ends thereof, so that rotation of the fulcrum screw causes the arms to rotate about the pivot members associated with the leverage screw to open and close the jaws at a suitably high speed and rotation of the leverage screw causes the arms to rotate about the pivot members associated with the fulcrum screw to open and close the jaws with the force required to obtain a good clamping action. A pair of telescoping support members in Blake permit relative lateral movement between the fulcrum and leverage screws and prevent relative axial movement between the same screws are mounted on the fulcrum and leverage screws to limit skewing of the arms when the jaws are open. For Blake, preventing skewing is the primary goal as between the arms that plague a conventional “C” clamp for instance.

Continuing to look at clamping prior art solutions in U.S. Pat. No. 3,807,718 to Sendoykas, disclosed is a clamp having two spaced means for opposed angular relative clamping movement therebetween and each having a first pivot, plus actuation link members each attached at a different one of the first pivots and pivotally attached together to provide a toggle action between said first pivots, and characterized by a second pivot adjacent the first pivot on each of the opposed spaced means.

Further, Sendoykas has two cross links attached each at one end to each second pivot, and each cross link having its other end pivotally attached to the other opposed spaced means, the attachment of the cross links being such that an imaginary line joining the centers of the pivots of one cross link intersects an imaginary line joining the centers of the pivots of the other cross link. In Sendoykas, the novelty is in the relative movement of the handle to the jaws, see claim 4.

Further in looking at clamping prior art solutions in U.S. Pat. No. 7,104,166 to Wong disclosed is a multi-purpose locking plier having a fixed handle and a movable handle linked together by a spring and a toggling linkage mechanism similar to the design of a conventional locking plier. Wong includes an L-shaped extendable fixed arm with one end riveted to a first end of said fixed handle and the other end made to be cylindrical in shape with a first threaded hole; an L-shaped extendable movable arm with one end pivoted to one end of the movable handle and the other end made to be cylindrical in shape with a second threaded hole. In addition Wong has an adjustment screw fed into a second end of said fixed handle, the adjustment screw having a cylindrical head with a cylindrical hole made perpendicular to its axis.

In Wong, the plurality of clamping heads, each with a unique design feature and a threaded rod being fed into said first threaded hole of said L-shape extendable fixed arm or the second threaded hole of the L-shape extendable movable arm, that also include: a fixed clamping pad, a swivel clamping pad, a rubber clamping pad, and a yoke assembly. Wong also has a plurality of accessories, each with a unique design feature and a hole being attached with screw to said first threaded hole of said L-shape extendable fixed arm or the second threaded hole of the L-shaped extendable movable arm, including: a V-pad, a long L-shaped link, a short L-shaped link, a 180 degree V-angle bracket, a 90 degree V-angle bracket, a 180 degree L-angle bracket, a 90 degree L-angle bracket, a support bar, and a L-shape clamping arm with slip-on jaw. Wong is brought into the search for the clamping pads, wherein arm adjustability is the novelty in Wong.

Continuing in looking at clamping prior art solutions in U.S. Pat. No. 6,000,686 to Yates disclosed is a locking, three-way clamp for applying a bi-directional vector force against one or more work pieces. The clamp in Yates, of the present invention, includes a handle, first and second opposing jaws and, respectively, a jaw actuation lever, a threaded adjusting screw and a toggle lock. Yates also has second opposing jaw pivots, in relation to first jaw, about a central pivot point plus first and second opposing jaws that each include a distal end respectively. A work piece restraint member in Yates can be utilized for providing a rigid planar surface for engagement with a work piece and the locking three-way clamp of the present invention also includes an engagement device, being on the distal end of each jaw, that pivots inward towards the restraint member thus applying a vector force having x- and y-component vectors that forces a first work piece against a second work piece and simultaneously forcing the clamp towards the work pieces, se in particular FIG. 3.

In one embodiment in Yates, the engagement devices are defined by a opposing, eccentrically mounted cams pivotally secured proximate to the distal ends and of the jaws and in a second embodiment, the engagement device is defined by a linkage assembly pivotally secured proximate the distal ends and of the jaws and of the clamp. Each linkage assembly in Yates pivots in relation to distal ends of the jaws about a first pivot point and includes a work head that pivots in relation to linkage assembly about a second pivot point. Yates in similar to Wong, except for the arm terminations having eccentric roller clamps for imparting a two dimensional force for clamping.

Yet further, in looking at clamping prior art solutions in U.S. Pat. No. 6,945,523 to Degen, disclosed is a bar type clamping tool, comprising: a first clamping jaw releasably mounted on a rail bar by a bolt extending into an opening in the rail, the bolt being removable from the opening and insertable into another opening in the rail such that the first clamping jaw is mounted on the rail at another position. Further in Degen, a second clamping jaw is mounted on the rail and displaceable by a clamping device into a clamping position in a direction toward the first clamping jaw and displaceable in a direction away from the first clamping jaw wherein a spring having a force applied to the bolt such that the bolt is retained in an engagement position in the opening with the first clamping jaw. Degen has a push button coupled to the bolt, the spring being subject to stressing when the bolt is displaced out of the opening by pressure applied to the push button. The bolt stressing in Degen is the novel part of this invention, i.e. that locks the clamp on the beam when loaded and unlocks the clamp on the beam when unloaded.

There exists therefore a need for an acupressure clamp that is simple in design having minimal parts for a lower cost, however, retaining the desirable features of a course adjustment and a fine adjustment for the selectable amount of acupressure to be applied to a specific body part such as in the Mills and Eglauf references. In addition, a desirable acupressure clamp would be small and portable, plus not require any specific tools to operate.

### BRIEF DESCRIPTION OF DRAWINGS

FIG. 1 shows a perspective view of the clamp apparatus that shows the first and second fingers, the first and second proximal end portions, the first and second distal end portions, the first and second finger cross sections, the first and second apertures, the first and second aperture axes, the coincident position of the first and second aperture axes, the connecting member, the structure of the connecting member, the cross section of the connecting member, the affixment as between the first finger proximal portion the connecting member, and the second finger proximal portion, further shown is the “V” shape of the first and second fingers and the connecting member, the first and second extensions, the first and second extension axes, the first and second elongated threaded portions, and the first and second shoes, further shown are first and second magnets, first and second primary channels, and first and second resilient protrusion elements;

FIG. 2 shows a side elevation view of the clamp apparatus that shows the first and second fingers, the first and second proximal end portions, the first and second distal end portions, the first and second aperture axes, the coincident position of the first and second aperture axes, the connecting member, the affixment as between the first finger proximal portion the connecting member, and the second finger proximal portion, further the “V” shape of the first and second fingers and the connecting member, the first and second extensions, the first and second extension axes, the first and second elongated threaded portions, and the first and second shoes, further shown are first and second magnets, first and second primary channels, and first and second resilient protrusion elements, further shown are first and second magnets, first and second primary channels, and first and second resilient protrusion elements;

FIG. 3 shows cross sectional view cut 3-3 from FIG. 1, wherein FIG. 3 shows the first and second fingers, the first and second proximal end portions, the first and second distal end portions, the first and second finger threaded openings, the first and second apertures, the first and second aperture axes, the coincident position of the first and second aperture axes, the connecting member, the affixments as between the first finger proximal portion the connecting member and the second finger proximal portion, further the “V” shape of the first and second fingers and the connecting member, the first and second extensions, the first and second extension axes, the first and second elongated threaded portions, the first and second threadable engagements, and the first and second shoes, further shown are the first and second magnets and the first and second resilient protrusion elements;

FIG. 4 shows view 4-4 from FIG. 2, wherein FIG. 4 shows the first finger, the first finger distal portion, the first finger proximal portion, the first finger axis, the first finger cross section, the first threaded opening axis, the first threaded opening, the first aperture, the first aperture axis, the threaded fastener, and a threadably engaged nut, further shown are the first primary open channel and the first secondary open channel, plus the first resilient protrusion element;

FIG. 5 shows a perspective view of the clamp apparatus in one of its uses as an acupressure clamp in position in the body part of the hand webbing as between the thumb and the index finger also known as position LI4 that is believed to control the large intestine, wherein the means for overcoming the connecting member urging is employed via the fastener and threadably engaged nuts in conjunction with the first and second (not shown) extensions, the first and second (not shown) shoes, plus the first and second fingers, and the connecting member, further shown are the first primary open channel and the first secondary open channel, plus the first resilient protrusion element;

FIG. 6 shows a perspective view of the clamp apparatus in one of its uses as an acupressure clamp in position in the body part of the hand for the small finger palm, wherein the means for overcoming the connecting member urging is employed via the fastener and threadably engaged nuts in conjunction with the first and second (not shown) extensions, the first and second (not shown) shoes, plus the first and second fingers, and the connecting member, further shown are the first primary open channel and the first secondary open channel, plus the first resilient protrusion element;

FIG. 7 shows a combined plan view of the first and second extension axes and the first and second primary open channels, the first and second secondary open channels, also shown is the first and second resilient protrusion elements, wherein with the rotational rotation of the first or second elongated threaded portions about the first and second extension axes with the first and second resilient protrusion elements are shown being received into the first and second secondary open channels;

FIG. 8 shows a combined plan view of the first and second extension axes and the first and second primary open channels, the first and second secondary open channels, also shown is the first and second resilient protrusion elements, wherein with the rotational rotation of the first or second elongated threaded portions about the first and second extension axes with the first and second resilient protrusion elements are shown being deflected with slidable contact on the first or second elongated threaded portions;

FIG. 9 shows an end view of the first and second shoe portions that include the first and second magnets that further include the first north pole portion and first south pole portion, plus the second north pole portion and second south pole portion with the first and second bifurcations plus the first and second intersecting axes, in addition the rotational rotation of the first or second shoe portions about the first and second extension axes; and

FIG. 10 shows perspective end views of the first and second shoe portions that is an expanded partial version of FIG. 1, wherein FIG. 10 shows the first and second shoe portions that include the first and second magnets that further include the first north pole portion and first south pole portion, plus the second north pole portion and second south pole portion with the first bifurcation of the first north and first south pole portions, also the second bifurcation of the second north and second south pole portions, plus the first and second intersecting axes, in addition the rotation of the first magnet first north and first south pole portions along with the first elongated thread portion about the first extension axis, plus the rotation of the second magnet second north and second south pole portions along with the second elongated thread portion about the second extension axis.

### SUMMARY OF INVENTION

The present invention is a clamp apparatus for clamping an article, the clamp apparatus includes a first finger with a first proximal end portion and an opposing first distal end portion with a first finger axis spanning therebetween, also a second finger with a second proximal end portion and an opposing second distal end portion with a second finger axis spanning therebetween. Further included is a biased flexible connecting member with structure to limit the bias, the connecting member is affixed to the first proximal end portion and the second proximal end portion, wherein a “V” shape is formed as between the first finger axis of the first finger, the connecting member, and the second finger axis of the second finger. The connecting member urges through the bias the first and second fingers apart from one another to be limited within the “V” shape, wherein operationally the first distal end portion and the second distal end portion have opposing flexible movement relative to one another.

Also included the clamp apparatus is a means for overcoming the connecting member urging via manually selectively bringing the first distal end portion and the second distal end portion toward one another in a lockable manner. In addition, included is a first extension disposed adjacent to the first distal end portion, the first extension terminating in a first shoe portion, wherein the first shoe portion faces the second distal end portion and a second extension disposed adjacent to the second distal end portion, the second extension terminating in a second shoe portion, wherein the second shoe portion faces the first distal end portion, wherein operationally the first and second shoe portions act to clamp the article to the extent of the means.

These and other objects of the present invention will become more readily appreciated and understood from a consideration of the following detailed description of the exemplary embodiment(s) of the present invention when taken together with the accompanying drawings, in which;

### REFERENCE NUMBERS IN DRAWINGS

50 Clamp apparatus
55 Article
60 Body part for acupressure
65 Clamping the article
70 First finger
75 First proximal end portion of the first finger 70
80 First aperture of the first proximal end portion 75
85 First aperture axis
90 First distal end portion of the first finger 70
95 First threaded opening
100 First threaded opening axis
105 Perpendicular position of the first threaded opening axis 100 to the first finger axis 115
110 First finger cross section
115 First finger axis
120 Second finger
125 Second proximal end portion of the second finger 120
130 Second aperture of the second proximal end portion 125
135 Second aperture axis
140 Second distal end portion of the second finger 120
145 Second threaded opening
150 Second threaded opening axis
155 Perpendicular position of the second threaded opening axis 150 to the second finger axis 165
160 Second finger cross section
165 Second finger axis
170 Coincident position of the first 85 and second 135 aperture axes
175 Biased flexible connecting member
180 Structure of the connecting member 175 to limit bias
185 Cross section of the connecting member 175
190 Affixed nature of connecting member 175 to the first 75 and second 125 proximal end portions
195 V shape formed from the first 70 and second 120 fingers and connecting member 175
200 Bias of the first 70 and second 120 fingers apart from one another
205 Opposing flexible movement of the first 90 and second 140 distal end portions to one another
210 Means for overcoming the connecting member 175 urging
215 Manually selectively bringing the first 90 and second 140 distal end portions toward one another
220 Locking the first 90 and second 140 distal end portions in a selected position toward one another
225 First extension
230 First extension axis
235 First elongated threaded portion of the first extension 225
240 First threadable engagement
245 First shoe portion
250 Facing of the first shoe portion 245 to the second distal end portion 140
255 First elastomeric expanded element of the first shoe 245
260 First elastomeric expanded convex disc of the first shoe 245
265 Larger area of the first shoe 245 and first magnet 360 perpendicular to the first extension axis 230 than the first elongated threaded portion 235 area perpendicular to the first extension axis 230
270 Second extension
275 Second extension axis
280 Second elongated threaded portion of the second extension 270
285 Second threadable engagement
290 Second shoe portion
295 Facing of the second shoe portion 290 to the first distal end portion 90
300 Second elastomeric expanded element of the second shoe 290
305 Second elastomeric expanded convex disc of the second shoe 290
310 Larger area of the second shoe 290 and second magnet 400 perpendicular to the second extension axis 275 than the second elongated threaded portion 280 area perpendicular to the second extension axis 275
315 Flexible structural stiffness K factor
320 Threaded fastener
325 Threadably engaged nuts
330 Nuts position outside of the V shape 195
335 Further clamping force adjustment
350 First rotational engagement
355 Second rotational engagement
360 First magnet
365 First magnet that is permanent
370 First magnet positioned to face the second distal end portion 140
375 First north pole portion
380 First south pole portion
385 First bifurcation of the first north 375 and first south 380 pole portions
390 First intersecting axis
395 Perpendicular position of the first intersecting axis 390 to the first extension axis 230
400 Second magnet
405 Second magnet that is permanent
410 Second magnet positioned to face the first distal end portion 90
415 Second north pole portion
420 Second south pole portion
425 Second bifurcation of the second north 415 and second south 420 pole portions
430 Second intersecting axis
435 Perpendicular position of the second intersecting axis 430 to the second extension axis 275
440 Rotationally positionally oriented first 360 and second 400 magnets
445 Magnetic attraction as between the first 245 and second 290 shoe portions with the first north pole portion 375 and the second south pole portion 420 being selectively placed directly across from one another
450 Magnetic repulsion as between the first 245 and second 290 shoe portions with the first north pole portion 375 and the second north pole portion 415 being selectively placed directly across from one another
455 First primary open channel
460 Parallel position of the first extension axis 230 to the lengthwise portion of the first primary open channel 455
465 First secondary open channel
470 Parallel position of the first extension axis 230 to the lengthwise portion of the first secondary open channel 465
475 First resilient protrusion element
480 First resilient protrusion element 475 disposed on the first distal end portion 90
485 Receiving of the first resilient protrusion element 475 in either the first primary 455 or first secondary 465 open channels
490 Deflecting out of the first resilient protrusion element 475 from either the first primary 455 or first secondary 465 open channels then having a slidable contact 495 with the first elongated threaded portion 235
495 Slidable contact of the first resilient protrusion element 475 with the first elongated threaded portion 235
500 Rotation of the first elongated threaded portion 235 about the first extension axis 230
505 Second primary open channel
510 Parallel position of the second extension axis 275 to the lengthwise portion of the second primary open channel 505
515 Second secondary open channel
520 Parallel position of the second extension axis 275 to the lengthwise portion of the second secondary open channel 515, this is not shown, however, is similar to elements 460, 470, and 510 that are shown
525 Second resilient protrusion element
530 Second resilient protrusion element 525 disposed on the second distal end portion 140
535 Receiving of the second resilient protrusion element 525 in either the second primary 505 or second secondary 515 open channels
540 Deflecting out of the second resilient protrusion element 525 from either the second primary 505 or second secondary 515 open channels then having a slidable contact 545 with the second elongated threaded portion 280
545 Slidable contact of the second resilient protrusion element 525 with the second elongated threaded portion 280
550 Rotation of the second elongated threaded portion 280 about the second extension axis 275

### DETAILED DESCRIPTION

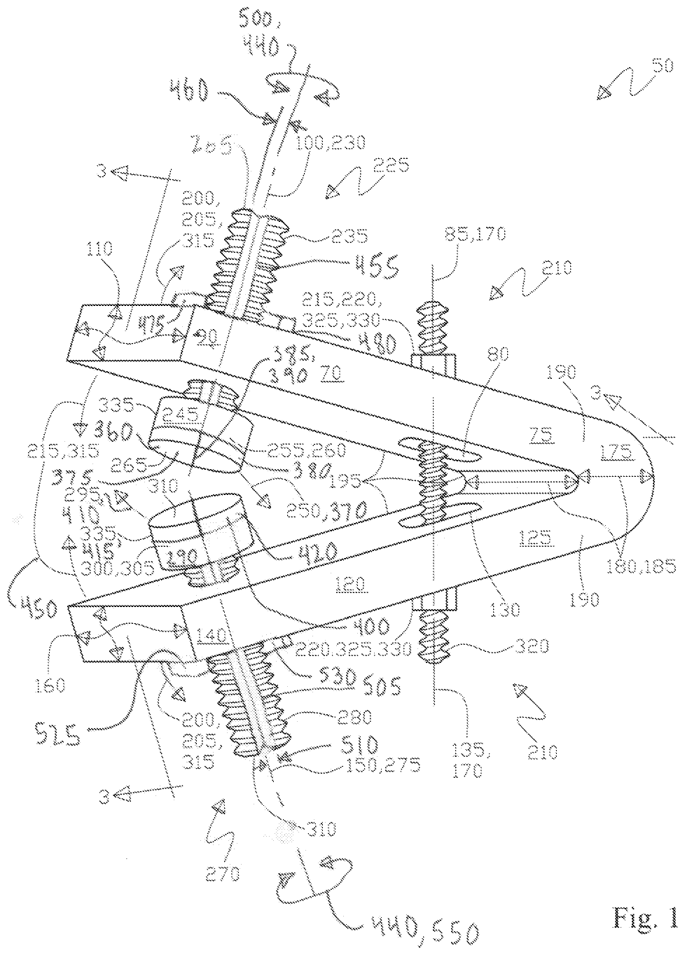

With initial reference to FIG. 1 shown is the perspective view of the clamp apparatus 50 that shows the first 70 and second 120 fingers, the first 75 and second 125 proximal end portions, the first 90 and second 140 distal end portions, the first 110 and second 160 finger cross sections, the first 80 and second 130 apertures, the first 85 and second 135 aperture axes, the coincident position 170 of the first 85 and second 135 aperture axes, and the connecting member 175. Further FIG. 1 shows the structure 180 of the connecting member 175, the cross section 185 of the connecting member 175, the affixment 190 as between the first finger 70 proximal portion 75 the connecting member 175, and the second finger 120 proximal portion 125, further the “V” shape 195 of the first 70 and second 120 fingers and the connecting member 175, the first 225 and second 270 extensions, the first 230 and second 275 extension axes, the first 235 and second 280 elongated threaded portions, and the first 245 and second shoes 290 are all shown. FIG. 1 further shows the first 360 and second 400 magnets, the first 455 and second 505 primary channels, and the first 475 and second 525 resilient protrusion elements.

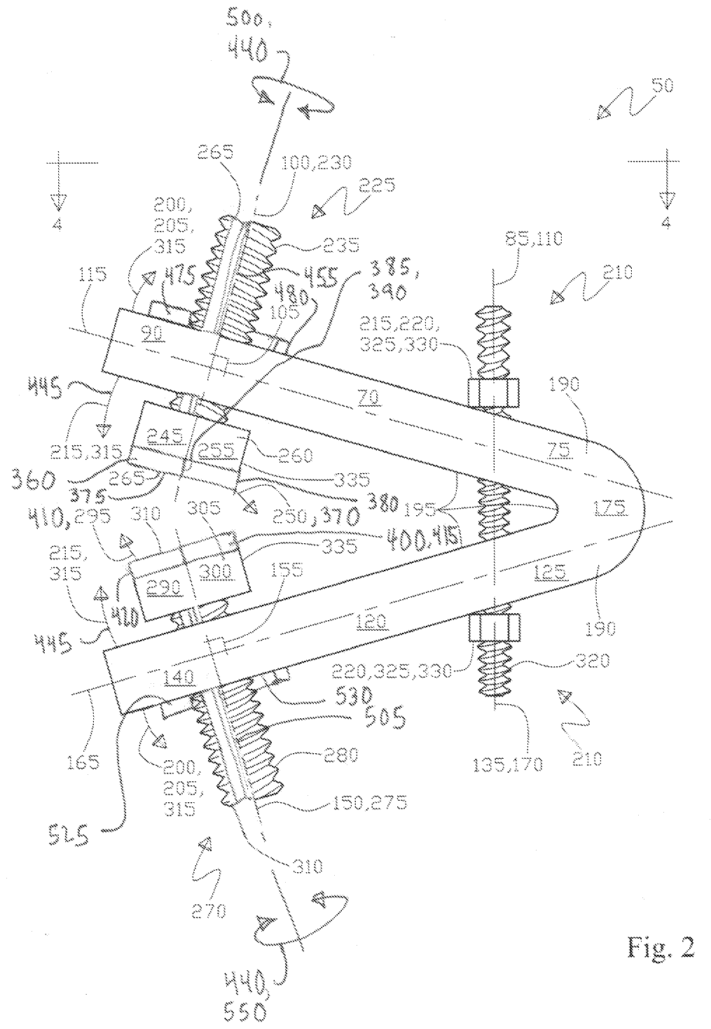

Continuing, FIG. 2 shows a side elevation view of the clamp apparatus 50 that shows the first 70 and second 120 fingers, the first 75 and second 125 proximal end portions, the first 90 and second 140 distal end portions, the first 85 and second 135 aperture axes, the coincident position 170 of the first 85 and second 135 aperture axes, the connecting member 175, the affixment 190 as between the first finger 70 proximal portion 75 the connecting member 175, and the second finger 120 proximal portion 125, further the “V” shape 195 of the first 70 and second 120 fingers and the connecting member 175, the first 225 and second 270 extensions, the first 230 and second 275 extension axes, the first 235 and second 280 elongated threaded portions, plus the first 245 and second 290 shoes are all shown. FIG. 2 further shows the first 360 and second 400 magnets, the first 455 and second 505 primary channels, and the first 475 and second 525 resilient protrusion elements.

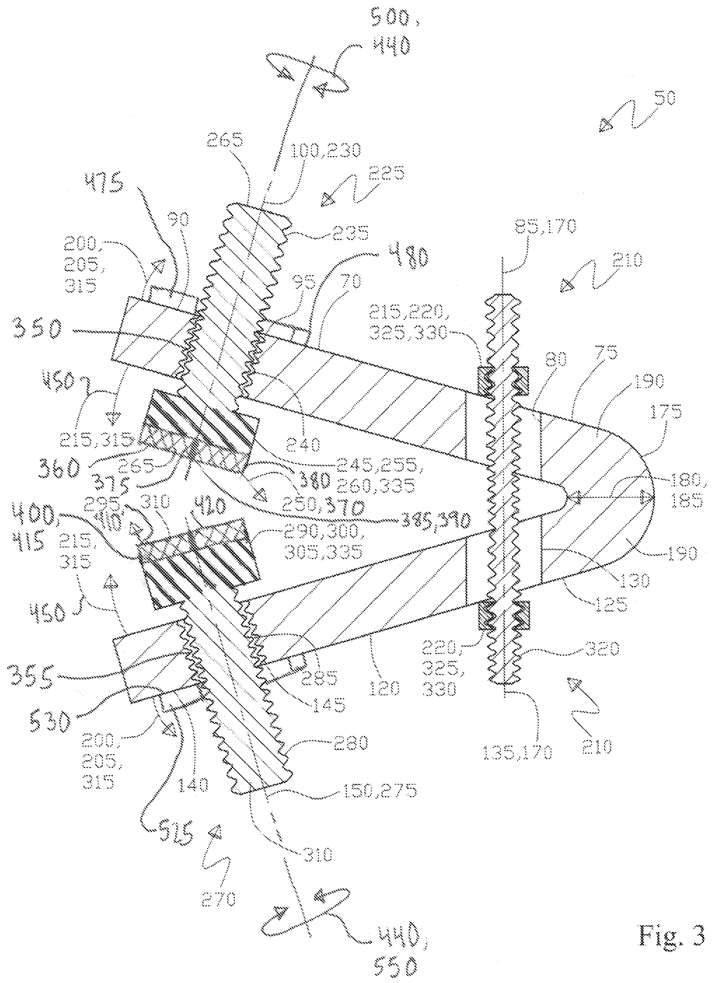

Next, FIG. 3 shows cross sectional view cut 3-3 from FIG. 1, wherein FIG. 3 shows the first 70 and second 120 fingers, the first 75 and second 125 proximal end portions, the first 90 and second 140 distal end portions, the first 95 and second 145 finger threaded openings, the first 80 and second 130 apertures, the first 85 and second 135 aperture axes, the coincident position 170 of the first 85 and second 135 aperture axes, and the connecting member 175. Also, FIG. 3 shows the affixments 190 as between the first finger 70 proximal portion 75 the connecting member 175 and the second finger 120 proximal portion 125, further the “V” shape 195 of the first 70 and second 120 fingers and the connecting member 175, the first 225 and second 270 extensions, the first 230 and second 275 extension axes, the first 235 and second 280 elongated threaded portions, the first 240 and second 285 threadable engagements, and the first 245 and second 290 shoes. FIG. 3 further shows the first 360 and second 400 magnets and the first 475 and second 525 resilient protrusion elements.

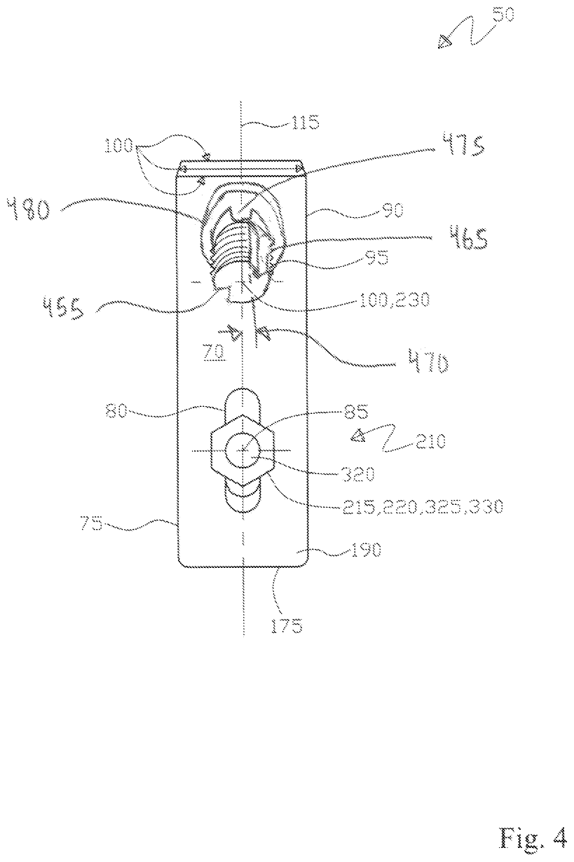

Further, FIG. 4 shows view 4-4 from FIG. 2, wherein FIG. 4 shows the first finger 70, the first finger distal portion 90, the first finger proximal portion 75, the first finger axis 115, the first finger cross section 110, the first threaded opening axis 100, the first threaded opening 95, the first aperture 80, the first aperture axis 85, the threaded fastener 320, and a threadably engaged nut 325. Also FIG. 4 further shows the first primary open channel 455 and the first secondary open channel 465, plus the first resilient protrusion element 475.

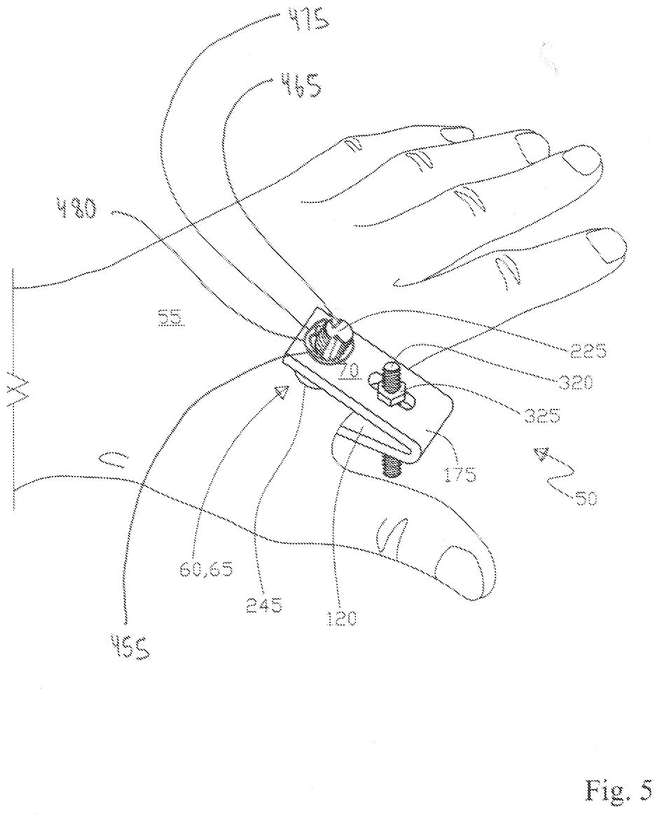

Continuing, FIG. 5 shows a perspective view of the clamp apparatus 50 in one of its uses as an acupressure clamp in position in the body part 60 of the hand webbing as between the thumb and the index finger also known as position LI4 that is believed to control the large intestine wherein the means 210 for overcoming the connecting member 175 urging is employed via the fastener 320 and threadably engaged nuts 325 in conjunction with the first 225 and second 270 (not shown) extensions, the first 245 and second 290 (not shown) shoes, plus the first 70 and second 120 fingers, and the connecting member 175. Also FIG. 5 further shows the first primary open channel 455 and the first secondary open channel 465, plus the first resilient protrusion element 475.

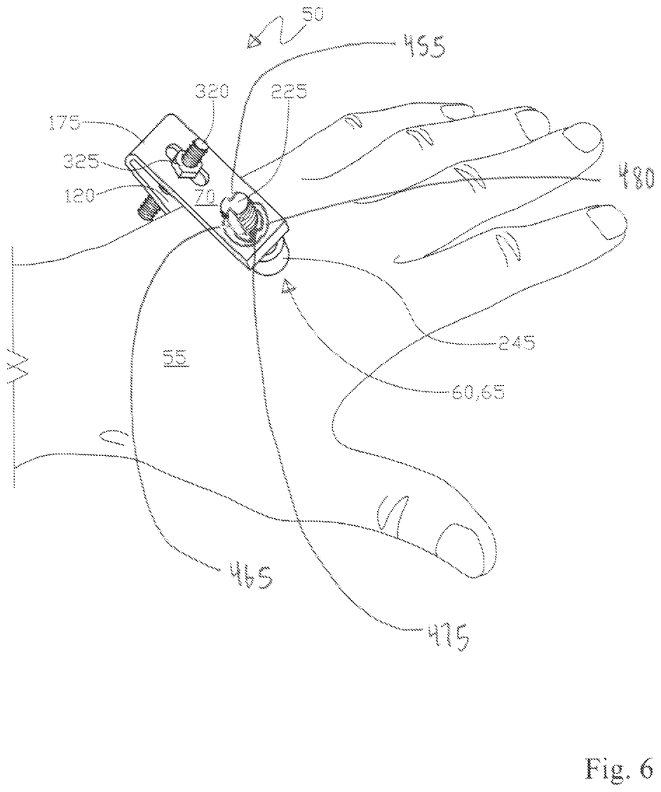

Next, FIG. 6 shows a perspective view of the clamp apparatus 50 in one of its uses as an acupressure clamp in position in the body part 60 of the hand for the small finger palm, wherein the means 210 for overcoming the connecting member 175 urging is employed via the fastener 320 and threadably engaged nuts 325 in conjunction with the first 225 and second 270 (not shown) extensions, the first 245 and second 290 (not shown) shoes, plus the first 70 and second 120 fingers, and the connecting member 175. Also FIG. 6 further shows the first primary open channel 455 and the first secondary open channel 465, plus the first resilient protrusion element 475.

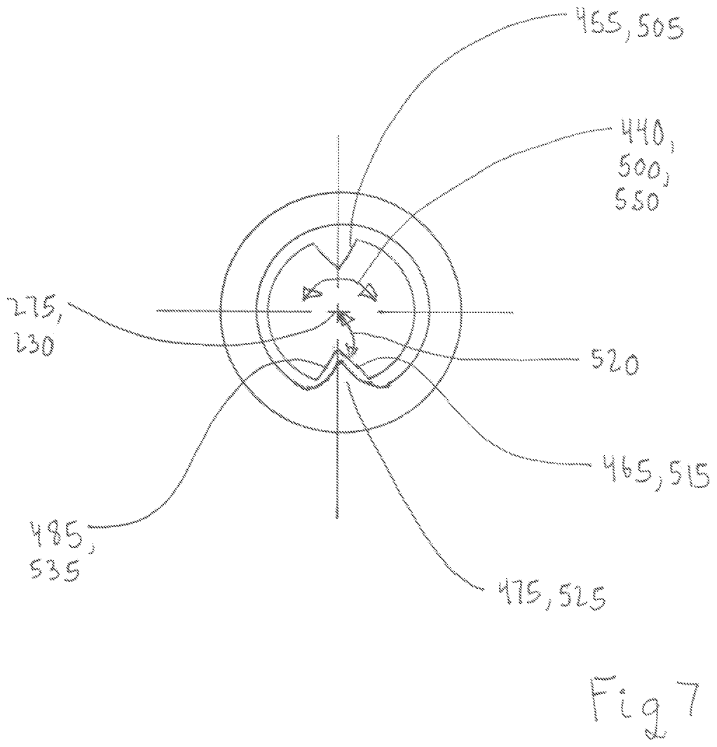

Moving on to FIG. 7 shows a combined plan view of the first 230 and second 275 extension axes and the first 455 and second 505 primary open channels, the first 465 and second 515 secondary open channels, also shown is the first 475 and second 525 resilient protrusion elements, wherein with the rotational rotation 440, 500, 550 of the first 235 or second 280 elongated threaded portions about the first 230 and second 275 extension axes with the first 475 and second 525 resilient protrusion elements are shown being received 485, 535 into the first 465 and second 515 secondary open channels, noting that also the first 475 and second 525 resilient protrusion elements can also be received 485, 535 into the first 455 and second 505 primary open channels, via rotation 440, 500, 550, although not shown in FIG. 7.

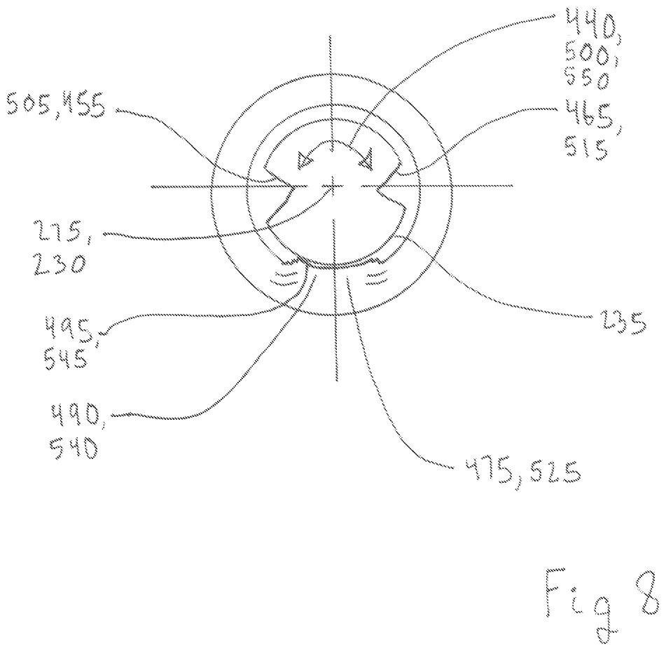

Continuing, FIG. 8 shows a combined plan view of the first 230 and second 275 extension axes and the first 455 and second 505 primary open channels, the first 465 and second 515 secondary open channels, also shown is the first 475 and second 525 resilient protrusion elements, wherein with the rotational rotation 440, 500, 550 of the first 235 or second 280 elongated threaded portions about the first 230 and second 275 extension axes with the first 475 and second 525 resilient protrusion elements are shown being deflected 490, 540 with slidable contact 495, 545 on the first 235 or second 280 elongated threaded portions.

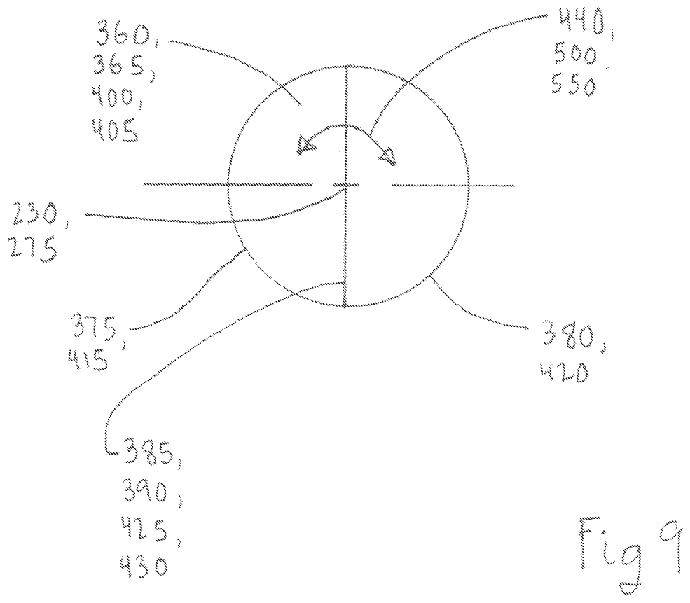

Next, FIG. 9 shows an end view of the combined first 245 and second 290 shoe portions that include the first 360 and second 400 magnets that further include the first north pole portion 375 and first south pole portion 380, plus the second north pole portion 415 and second south pole portion 420 with the first 385 and second 425 bifurcations plus the first 390 and second 430 intersecting axes, in addition the rotational rotation 440, 500, 550 of the first 245 or second 290 shoe portions about the first 230 and second 275 extension axes respectively.

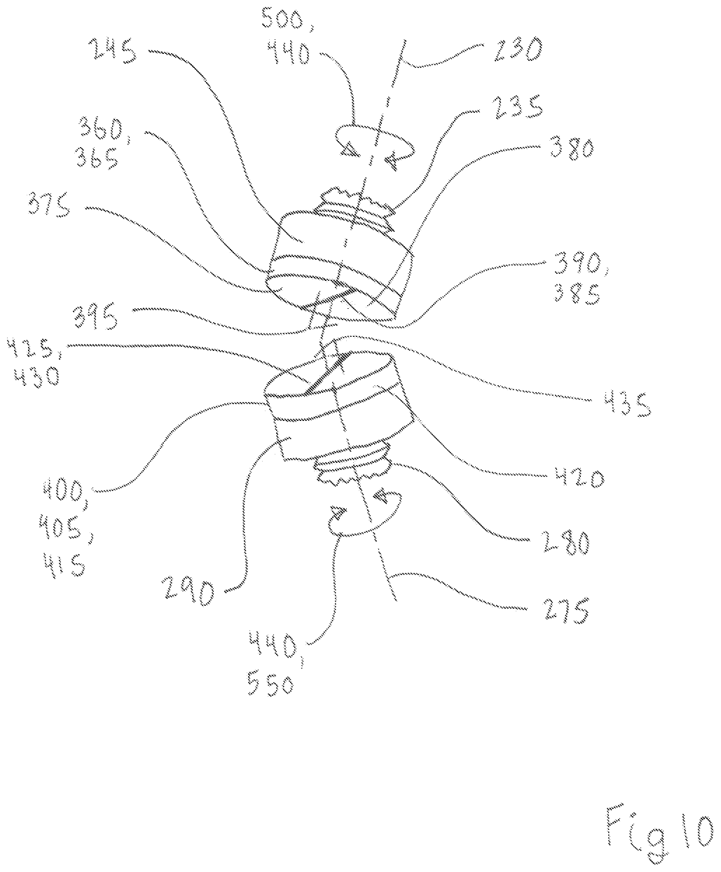

Continuing, FIG. 10 shows perspective end views of the first 245 and second 290 shoe portions that is an expanded partial version of FIG. 1, wherein FIG. 10 shows the first 245 and second 290 shoe portions that include the first 360 and second 400 magnets that further include the first north pole portion 375 and first south pole portion 380, plus the second north pole portion 415 and second south pole portion 420 with the first bifurcation 385 of the first north 375 and south 380 pole portions, also the second bifurcation 425 of the second north 415 and south 420 pole portions. Further, FIG. 10 shows the first 390 and second 430 intersecting axes, in addition the rotation 440, 500 of the first magnet 360 first north 375 and first south 380 pole portions along with the first elongated thread portion 235 about the first extension axis 230, plus the rotation 440, 550 of the second magnet 400 second north 415 and second south 420 pole portions along with the second elongated thread portion 280 about the second extension axis 275.

The present invention is the clamp apparatus 50 for clamping 65 an article 55, the clamp apparatus 50 includes the first finger 70 with the first proximal end portion 75 and the opposing first distal end portion 90 with the first finger axis 115 spanning therebetween, also the second finger 120 with the second proximal end portion 125 and the opposing second distal end portion 140 with the second finger axis 165 spanning therebetween, see FIGS. 1 to 10. Further included is the biased flexible connecting member 175 with structure 180 to limit the bias 200, the connecting member 175 is affixed 190 to the first proximal end portion 75 and the second 125 proximal end portions wherein the “V” shape 195 is formed as between the first finger axis 115 of the first finger 70, the connecting member 175, and the second finger axis 165 of the second finger 120 see FIGS. 1 to 3. The connecting member 175 urges through the bias 200 the first 70 and second 120 fingers apart 205 from one another to be limited within the “V” shape 195, see FIGS. 1 to 3. Wherein operationally the first distal end portion 90 and the second distal end portion 140 have opposing flexible movement 205 relative to one another, see FIGS. 2 and 3 in particular, plus FIG. 1.

Also included the clamp apparatus 50 is the means 210 for overcoming the connecting member 175 urging 200 via manually selectively bringing the first distal end portion 90 and the second distal end portion 140 toward one another 215 in a lockable manner 220, see in particular FIG. 3, plus FIGS. 1, 2, and 4, also see FIGS. 5 and 6 for the clamp apparatus 50 in use.

Also included the clamp apparatus 50 is the first extension 225 having a first rotational engagement 350 to the first distal end portion 90, the first extension 225 terminating in a first shoe portion 245, wherein the first shoe portion 245 faces the second distal end portion 140, the first shoe portion 245 includes a first magnet 360, wherein the first magnet 360 is positioned to face 370 the second distal end portion 140, the first magnet 360 is divided into a first north pole portion 375 and a first south pole portion 380, wherein the first north 375 and south 380 pole portions have a first bifurcation 385 about a first intersecting axis 390 that is perpendicular 395 to a first extension axis 230, see FIGS. 1 to 3, and FIG. 10.

Further included the clamp apparatus 50 is the second extension 270 having a second rotational engagement 355 to the second distal end portion 140, the second extension 270 terminating in a second shoe portion 290, wherein the second shoe portion 290 faces 295 the first distal end portion 90, the second shoe portion 290 includes a second magnet 400, wherein the second magnet 400 is positioned to face 410 the first distal end portion 90, the second magnet 400 is divided into a second north pole portion 415 and a second south pole portion 420, wherein the second north 415 and south 420 pole portions have the second bifurcation 425 about a second intersecting axis 430 that is perpendicular 435 to a second extension axis 275, wherein operationally the first 245 and second 290 shoe portions act to selectively clamp 65 or compress the article 55 to the extent of the means 210. Wherein the means 210 for overcoming the connecting member 175 will selectively automatically uncompress the article 55 via reversing the means 210, however, not less than the limited “V” shape 195 to prevent inadvertent dislodging of the clamp apparatus 50 from the article 55 with the means 210 completely reversed having no overcoming of the connecting member 175 opposite flexible movement 205. Further operationally, the first 360 and second 400 magnets can be independently rotationally 440, 500, 550 positionally orientated about the first 230 and second 275 extension axes to have magnetic attraction 445 between the first 245 and second 290 shoe portions with the first north pole portion 375 and the second south pole portion 420 being selectively placed directly across from one another and conversely the first 360 and second 400 magnets can be independently rotationally 440, 500, 550 positionally orientated about the first 230 and second 275 extension axes to have magnetic repulsion 450 between the first 245 and second 290 shoe portions with the first north pole portion 375 and the second north pole portion 415 being selectively rotationally placed 440, 500, 550 directly across from one another, thus adding an additional level of adjustment for clamp force 335 as between the first 245 and second 290 shoe portions, see FIGS. 1 to 3, and 7 to 10.

As an option, for the clamp apparatus 50 for clamping 65 the article 55, the first finger 70, the connecting member 175, and the second finger 120 can preferably have a combined flexible structural stiffness K factor 315 of about 32 pounds per inch as between the first 90 and second 140 distal end portions due to the first finger cross section 110, the connecting member cross section 180, 185, and the second finger cross section 160, using the cross sections inertia (inches to the fourth power) as is known in the art with preferably a mild carbon steel or stainless steel, or possibly a flexible plastic used for material of the first 70 and second 120 fingers, plus the connecting member 175, see FIG. 1 in particular. Wherein the K factor stiffness 315 is operational for the means 210 for overcoming the connecting member 175 urging 200 to have a desirable amount of manual 215 effort for selectively bringing the first 90 and second 140 distal end portions together, see FIGS. 1, 2, and 3.

Further, as an option for the clamp apparatus 50 for clamping 65 the article 55, the means 210 for overcoming the connecting member 175 urging 200 is preferably constructed of the threaded fastener 320 that includes the pair of threadably engaged nuts 325 which may be wing nuts as known in the art (not shown) for eliminating the need for tools, as best shown in FIG. 3, also see FIGS. 1 and 2, and finally FIGS. 4, 5, and 6. Another option for the clamp apparatus 50 for clamping 65 the article 55, can further include the first proximal end portion 75 having the first aperture 80 disposed therethrough with the first aperture axis 85 and the second proximal end portion 125 has the second aperture 130 disposed therethrough with the second aperture axis 135, as best shown in FIG. 3. Wherein the first 85 and second 135 aperture axes are coincident 170 with one another, wherein the threaded fastener 320 is disposed therethrough both of the first 80 and second 130 apertures, wherein each threadably engaged nut 325 is disposed outside 330 of the “V” shape 195 on opposing ends of the threaded fastener 320, see in particular FIG. 3, plus FIGS. 1 and 2. Wherein operationally, the threadably engaged nut 325 is tightened to selectively 215 bring the first distal end portion 90 and the second distal end portion 140 toward one another in a lockable manner 220, also see FIGS. 4, 5, and 6.

Yet a further option for the clamp apparatus 50 for clamping 65 the article 55, wherein the first extension 225 is preferably constructed of the first elongated threaded portion 235 having the first extension axis 230, wherein the first elongated threaded portion 235 terminates on one end at the first shoe 245, see FIGS. 1 to 3. Wherein the first distal end portion 90 including the first threaded opening 95 having the first threaded opening axis 100 that is positioned perpendicular 105 to the first finger axis 115, such that the first elongated threaded portion 235 has the first threadable engagement 240 to the first threaded opening 95, see FIG. 3 in particular. Wherein the first extension 225 facilitates further clamping force 335 adjustment upon the article 55 via the first threadable engagement 240, again see FIG. 3 in particular and FIGS. 1 and 3, plus FIGS. 5 and 6 for the use view of the first extension 225.

Another option for the clamp apparatus 50 for clamping 65 the article 55, wherein the second extension 270 is preferably constructed of the second elongated threaded portion 280 having the second extension axis 275, wherein the second elongated threaded portion 280 terminates on one end at the second shoe 290, see FIGS. 1 to 3. Wherein the second distal end portion 140 including the second threaded opening 145 having the second threaded opening axis 150 that is positioned perpendicular 155 to the second finger axis 165, such that the second elongated threaded portion 280 has the second threadable engagement 285 to the second threaded opening 145, see FIG. 3. Wherein the second extension 270 facilitates further clamping force 335 adjustment upon the article 55 via the second threadable engagement 285, again see FIG. 3 in particular and FIGS. 1 and 3, plus FIGS. 5 and 6 for the use view of the second extension 270 (not shown) being similar to the first extension 225 (shown).

An even further option for the clamp apparatus 50 for clamping 65 the article 55, wherein the first shoe 245 is preferably constructed of a first elastomeric expanded element 255 supporting the first magnet 360 that is a first permanent magnet 365, wherein both the first elastomeric element 255 and the first permanent magnet 365 have a larger area 265 perpendicular to the first extension axis 230 than the first elongated threaded portion 235 area perpendicular to the first extension axis 230 for operationally increasing a clamping 65 area upon the article 55 to lessen a unit loading from the first shoe 245 upon the article 55, see in particular FIG. 1, then FIGS. 2, 3, and 4, plus FIGS. 5 and 6 for the use view of the clamping apparatus 50, in addition see FIG. 10.

Continuing for another option for the clamp apparatus 50 for clamping 65 the article 55, wherein the second shoe 290 is preferably constructed of a second elastomeric expanded element 300 supporting the second magnet 400 that is a second permanent magnet 405, wherein both the second elastomeric element 300 and the second permanent magnet 405 have a larger area 310 perpendicular to the second extension axis 275 that the second elongated threaded portion 280 area perpendicular to the second extension axis 275 for operationally increasing a clamping 65 area upon the article 55 to lessen a unit loading from the second shoe 290 upon the article 55, see in particular FIG. 1, then FIGS. 2, 3, and 4, plus FIGS. 5 and 6 for the use view of the clamping apparatus 50, also see FIG. 10.

As an option for the clamp apparatus 500 for clamping the article 55 wherein the first elongated threaded portion 235 further includes a first primary open channel 455 that is lengthwise disposed parallel 460 to the first extension axis 230 and an oppositely disposed in relation to the first extension axis 230, the first secondary open channel 465 that is lengthwise disposed parallel 470 to the first extension axis 230, further a first resilient protrusion element 475 is disposed 480 on the first distal end portion 90. Wherein the first resilient protrusion element 475 is sized and configured to be received 485 in either of the first primary 455 or first secondary 465 open channels and to deflect out 490 of either the first primary 455 or first secondary 465 open channels having a slidable contact 495 with the first elongated threaded portion 235 outside of the first primary 455 or first secondary 465 open channels via rotation 500 of the first elongated threaded portion 235 about the first extension axis 230. This is to operationally cause a rotational detent of the first elongated threaded portion 235 about the first extension axis 230 at every half turn (or 180 degrees) to enable easier rotational setting of the first north pole portion 375 and the first south pole portion 380 of the first magnet 360, see FIGS. 1 to 10 and in particular FIGS. 7 to 10.

As another option for the clamp apparatus 50 for clamping an article 55, wherein the second elongated threaded portion 280 further includes a second primary open channel 505 that is lengthwise disposed parallel 510 to the second extension axis 275 and an oppositely disposed in relation to the second extension axis 275, the second secondary open channel 515 that is lengthwise disposed parallel 520 to the second extension axis 275, further a second resilient protrusion element 525 that is disposed 530 on the second distal end portion 140, wherein the second resilient protrusion element 525 is sized and configured to be received 535 in either of the second primary 505 or second secondary 515 open channels and to deflect 540 out of either the second primary 505 or second secondary 515 open channels having a slidable contact 545 with the second elongated threaded portion 280 outside of the second primary 505 or second secondary 515 open channels via rotation 550 of the second elongated threaded portion 280 about the second extension axis 275, this is to operationally cause a rotational detent of the second elongated threaded portion 280 about the second extension axis 275 at every half turn (or 180 degrees) to enable easier rotational setting of the second north pole portion 415 and the second south pole portion 420 of the second magnet 400, see FIGS. 1 to 10 and in particular FIGS. 7 to 10.

Continuing, on the options for the clamp apparatus 50 for clamping 65 the article 55 or body part 60 for acupressure, wherein the first shoe 245 is preferably constructed of a first elastomeric expanded convex disc 260 that has a larger area 265 perpendicular to the first extension axis 230 than the first elongated threaded portion 235 area perpendicular to the first extension axis 230 for operationally increasing a clamping 65 area upon the body part 60 for acupressure comfort, see in particular FIG. 1, then FIGS. 2, 3, and 4, plus FIGS. 5 and 6 for the use view of the clamping apparatus 50.

Continuing, on the options for the clamp apparatus 50 for clamping 65 the article 55 or body part 60 for acupressure, wherein the second shoe 290 is preferably constructed of a second elastomeric expanded convex disc 305 that has a larger area 310 perpendicular to the second extension axis 275 than the second elongated threaded portion 280 area perpendicular to the second extension axis 275 for operationally increasing a clamping 65 area upon the body part 60 for acupressure comfort, see in particular FIG. 1, then FIGS. 2, 3, and 4, plus FIGS. 5 and 6 for the use view of the clamping apparatus 50.

### Method of Use

Looking in particular at FIGS. 5 and 6, for the use of the clamp apparatus 50 which essentially has a course adjustment through the means 210 with the threaded fastener 320 and nuts 325, as shown in FIGS. 5 and 6 and then a fine adjustment in the first 225 and second 270 extensions that are threadably engaged 240, 285 via the threaded portions 235, 280 respectively in the first 70 and second 120 fingers. Wherein, the threaded portions 235, 280 have shoes 245, 290 that have an increased and rounded area 260, 265, 305, 310 for contact with the article 55 or body part 60 for acupressure. Also for further adjustability of the clamp apparatus 50, the rotational 500, 550 detent of the first 235 and/or second 280 elongated threaded portions about the first 230 and/or second 275 extension axes for every half turn (or 180 degrees) to enable easier rotational setting of the first north pole portion 375 and the first south pole portion 380 of the first magnet 360 and the second north pole portion 415 and the second south pole portion 420 of the second magnet 400, for corresponding magnetic attraction 445 and magnetic repulsion 450, see FIGS. 1 to 10 and in particular FIGS. 7 to 10.

### CONCLUSION

Accordingly, the present invention of a clamp apparatus 50 has been described with some degree of particularity directed to the embodiments of the present invention. It should be appreciated, though, that the present invention is defined by the following claims construed in light of the prior art so that modifications or changes may be made to the exemplary embodiments of the present invention without departing from the inventive concepts contained therein.

1. A clamp apparatus for clamping an article, comprising:
(a) a first finger with a first proximal end portion and an opposing first distal end portion with a first finger axis spanning therebetween;
(b) a second finger with a second proximal end portion and an opposing second distal end portion with a second finger axis spanning therebetween;
(c) a flexible connecting member that is affixed to said first proximal end portion and said second proximal end portion wherein said flexible connecting member forms a “V” shape as between said first finger axis of said first finger, said flexible connecting member, and said second finger axis of said second finger, said flexible connecting member creates an opposing flexible movement of said first and second distal end portions away from one another through said opposing flexible movement of said first and second fingers apart from one another to be limited within said “V” shape, wherein operationally said first distal end portion and said second distal end portion have opposing flexible movement relative to one another;
(d) a means for overcoming said connecting member opposing flexible movement via manually selectively bringing said first distal end portion and said second distal end portion toward one another in a lockable manner;
(e) a first extension having a first rotational engagement to said first distal end portion, said first extension terminating in a first shoe portion, wherein said first shoe portion faces said second distal end portion, said first shoe portion includes a first magnet, wherein said first magnet is positioned to face said second distal end portion, said first magnet is divided into a first north pole portion and a first south pole portion, wherein said first north and south pole portions have a first bifurcation about a first intersecting axis that is perpendicular to a first extension axis; and
(f) a second extension having a second rotational engagement to said second distal end portion, said second extension terminating in a second shoe portion, wherein said second shoe portion faces said first distal end portion, said second shoe portion includes a second magnet, wherein said second magnet is positioned to face said first distal end portion, said second magnet is divided into a second north pole portion and a second south pole portion, wherein said second north and south pole portions have a second bifurcation about a second intersecting axis that is perpendicular to a second extension axis, wherein operationally said first and second shoe portions act to selectively clamp or compress the article to the extent of said means, wherein said means for overcoming said connecting member will selectively automatically uncompress the article via reversing said means, however, not less than said limited “V” shape to prevent inadvertent dislodging of said clamp apparatus from the article with said means completely reversed having no said overcoming said connecting member opposite flexible movement, further operationally said first and second magnets can be independently rotationally positionally orientated about said first and second extension axes to have magnetic attraction between said first and second shoe portions with said first north pole portion and said second south pole portion being selectively placed directly across from one another and conversely said first and second magnets can be independently rotationally positionally orientated about said first and second extension axes to have magnetic repulsion between said first and second shoe portions with said first north pole portion and said second north pole portion being selectively placed directly across from one another, thus adding an additional level of adjustment for clamp force as between said first and second shoe portions.

2. A clamp apparatus for clamping an article according to claim 1 wherein said means for overcoming said flexible connecting member opposing flexible movement is constructed of a threaded fastener that includes a pair of threadably engaged nuts.

3. A clamp apparatus for clamping an article according to claim 2 wherein said first proximal end portion has a first aperture disposed therethrough with a first aperture axis and said second proximal end portion has a second aperture disposed therethrough with a second aperture axis, wherein said first and second aperture axes are coincident with one another, wherein said threaded fastener is disposed therethrough both of said first and second apertures, wherein each said threadably engaged nut is disposed outside of said “V” shape on opposing ends of said threaded fastener, wherein operationally said threadably engaged nut is tightened to selectively to bring said first distal end portion and said second distal end portion toward one another in a lockable manner.

4. A clamp apparatus for clamping an article according to claim 1 wherein said first extension is constructed of a first elongated threaded portion having said first extension axis, wherein said first elongated threaded portion terminates on one end at said first shoe, said first distal end portion first rotational engagement includes a first threaded opening having a first threaded opening axis that is positioned perpendicular to said first finger axis, wherein said first elongated threaded portion has a first threadable engagement to said first threaded opening, wherein said first extension facilitates further clamping force adjustment upon the article via said first threadable engagement.

5. A clamp apparatus for clamping an article according to claim 1 wherein said second extension is constructed of a second elongated threaded portion having said second extension axis, wherein said second elongated threaded portion terminates on one end at said second shoe, said second distal end portion second rotational engagement includes a second threaded opening having a second threaded opening axis that is positioned perpendicular to said second finger axis, wherein said second elongated threaded portion has a second threadable engagement to said second threaded opening, wherein said second extension facilitates further clamping force adjustment upon the article via said second threadable engagement.

6. A clamp apparatus for clamping an article according to claim 4 wherein said first shoe is constructed of a first elastomeric expanded element supporting said first magnet that is a first permanent magnet, wherein both said first elastomeric element and said first permanent magnet have a larger area perpendicular to said first extension axis than said first elongated threaded portion area perpendicular to said first extension axis for operationally increasing a clamping area upon the article to lessen a unit loading from said first shoe upon the article.

7. A clamp apparatus for clamping an article according to claim 5 wherein said second shoe is constructed of a second elastomeric expanded element supporting said second magnet that is a second permanent magnet, wherein both said second elastomeric element and said second permanent magnet have a larger area perpendicular to said second extension axis than said second elongated threaded portion area perpendicular to said second extension axis for operationally increasing a clamping area upon the article to lessen a unit loading from said second shoe upon the article.

8. A clamp apparatus for clamping an article according to claim 6 wherein said first elongated threaded portion further includes a first primary open channel that is lengthwise disposed parallel to said first extension axis and an oppositely disposed in relation to said first extension axis, a first secondary open channel that is lengthwise disposed parallel to said first extension axis, further a first resilient protrusion element that is disposed on said first distal end portion, wherein said first resilient protrusion element is sized and configured to be received in either of said first primary or first secondary open channels and to deflect out of either said first primary or first secondary open channels having a slidable contact with said first elongated threaded portion outside of said first primary or first secondary open channels via rotation of said first elongated threaded portion about said first extension axis, this is to operationally cause a rotational detent of said first elongated threaded portion about said first extension axis at every half turn to enable easier rotational positional setting of said first north pole portion and said first south pole portion of said first magnet.

9. A clamp apparatus for clamping an article according to claim 7 wherein said second elongated threaded portion further includes a second primary open channel that is lengthwise disposed parallel to said second extension axis and an oppositely disposed in relation to said second extension axis, a second secondary open channel that is lengthwise disposed parallel to said second extension axis, further a second resilient protrusion element that is disposed on said second distal end portion, wherein said second resilient protrusion element is sized and configured to be received in either of said second primary or second secondary open channels and to deflect out of either said second primary or second secondary open channels having a slidable contact with said second elongated threaded portion outside of said second primary or second secondary open channels via rotation of said second elongated threaded portion about said second extension axis, this is to operationally cause a rotational detent of said second elongated threaded portion about said second extension axis at every half turn to enable easier rotational positional setting of said second north pole portion and said second south pole portion of said second magnet.
